(19) United States
(12) Patent Application Publication
(10) Pub. No.: US 2019/0316032 A1
(43) Pub. Date: Oct. 17, 2019

(54) DUAL-USE, DUAL-FUNCTION POLYACRYLAMIDE PROPPANT SUSPENDING AGENT FOR FLUID TRANSPORT OF HIGH CONCENTRATIONS OF PROPPANTS

(71) Applicant: FRAC FORCE TECHNOLOGIES LLC, Big Sandy, TX (US)

(72) Inventors: Audis C. BYRD, Big Sandy, TX (US); Robert D. HUNT, Long Beach, MS (US); Larry M. SHULTZ, Beverly Hills, CA (US)

(21) Appl. No.: 16/278,204

(22) Filed: Feb. 18, 2019

Related U.S. Application Data
(60) Provisional application No. 62/632,593, filed on Feb. 20, 2018.

(51) Int. Cl. C09K 8/80; C08L 33/26; C08J 3/24

(52) U.S. Cl. CPC C09K 8/80; C08J 3/24; C08L 33/26

(57) ABSTRACT

A dual-function polyacrylamide proppant suspending agent is prepared by blending polyacrylamide in a concentration range of 0.10% to 0.90% active polyacrylamide material in an aqueous solution by weight of the mix fluid. The proppant suspending agent can suspend granular materials commonly used as fracturing proppants. The polyacrylamide active material is used on the surface as proppant suspending agent to suspend proppants at very high proppant concentration levels. The polyacrylamide and proppant are both diluted by a supply of dean proppant free fluid to concentration ranges for proppant and friction reducer (FR) commonly used in Waterfrac treatments with the resulting slurry being injected into the wellbore, through the casing of the well and into the reservoir at high rates with lowered surface treating pressures. The polyacrylamide active material performs two different functions at two different times during the hydraulic fracturing process.

### FIELD OF THE INVENTION

The present invention relates generally to systems and methods for hydraulic fracturing technologies, more specifically to a polyacrylamide fluid to suspend high concentrations of proppants for fluid transport in hydraulic fracturing surface pumping operations.

### BACKGROUND

Hydraulic fracturing of horizontal wells has unleased hydrocarbons from very tight reservoirs that once were considered as being unproductive reservoirs or simply source rocks for hydrocarbon. With the implementation of horizontal wells and closely spaced perforations for hydraulic fracturing, these once-believed nonproductive reservoirs have been transformed into a significant new source of crude oil and natural gas that have made the United States one of the world's largest oil and natural gas producers on its road to energy independence.

These new horizontal long-lateral wells and close space perforation have led to wells with fifty to a hundred stages and proppant volumes that exceed twenty-five to fifty million pounds of proppant being placed in each wellbore. Each well has a tremendous amount of proppant placed in it as compared to the old conventional vertical fracturing completions. Many of the well locations (pads) have multiple wells on them that are fracture stimulated with a single equipment rig up. Some pads may require over a hundred million pounds of proppant to complete all the wells on a single pad of wells. The multi-well pads normally use 24/7 fracturing operations, so the equipment utilization and volume of fluids and sands have increased more than one order of magnitude.

In the old conventional well completions, the same equipment could require a year or more to pump the same volume of fluids and proppant as current fracturing pumps are now required to pump in a single month. With this increased utilization and volume of proppant per wellbore, the monthly maintenance of the equipment has gone up exponentially due to proppant abrasion damage.

The abrasive nature of proppant-containing fracturing fluids wears out the internal components of the plunger pumps that are used to pump it. Thus, when plunger pumps are used to pump fracturing fluids, the repair, replacement and/or maintenance expenses for the internal components of the pumps are extremely high, and the overall life expectancy of the pumps is low. For example, when a plunger pump is used to pump a fracturing fluid, the pump fluid-end, valves, valve seats, packings, and plungers require frequent maintenance and/or replacement due to abrasive proppants at high pressures destroying those components.

The most damaging fluid is that containing the abrasive proppant. To reduce the number of pumps being damaged by the proppant slurry, the proppant concentration would need to be increased so that fewer fracturing pumps are required to pump the proppant laden slurry. Then the remaining pumps could pump a clean proppant-free fluid. At one time it was believed that lower concentrations of proppant would be less damaging to the pumps, but that has not proven to be true. What has been proven is that if there is proppant present, then there is damage, and if the proppant is not present, the damage is greatly reduced on the fracturing pumps. So, reducing the number of pumps to a minimum will reduce fracturing pump maintenance, down time and repair costs to a minimum.

Prior art U.S. Pat. No. 9,016,383 B2 titled, “SPLT STREAM OILFIELD PUMPING SYSTEMS” by Shampine et al. dated Apr. 28, 2015; applicant: Schlumberger Technology Corporation, teaches us the advantage of concentrating the proppant solids into a dirty stream so that they may be pumped by a limited number of dirty pumps from the surface to the wellbore, whereby the proppant concentration is diluted by the clean stream upon mixing of the two streams together at the wellbore to provide the desired proppant concentration, which is then injected into the wellbore.

The method of prior art U.S. Pat. No. 9,016,383 B2 splits a fracturing fluid stream into a clean stream having a minimal number of solids and a dirty stream having solids in a fluid carrier. Typically, proppant loadings from 2 PPA to 12 PPA (pounds of proppant added) maximum loading are used by the split stream method; and, thereby the method requires up to half (ten pumps) of the average fleet of pumper trucks to pump the dirty stream.

Prior art U.S. Pat. No. 9,016,383 B2 cites that it is a method of pumping an oilfield fluid from a well surface to a wellbore. The method includes providing a clean stream; operating one or more clean pumps to pump the clean stream from the well surface to the wellbore; providing a dirty stream including a solid material disposed in a fluid carrier, and operating one or more dirty pumps to pump the dirty stream from the well surface to the wellbore, wherein the clean stream and the dirty stream together form said oilfield fluid. The split stream method greatly increases the useful life of the clean pumps.

In the method of prior art U.S. Pat. No. 9,016,383 B2 in actual oilfield operations the process has required about half of the pumps to make up the dirty stream pumping the proppant laden slurry clue to the low proppant concentrations currently used in slickwater frac operations. A major detriment of the split stream method is that approximately half of the pumps are still damaged in the process because they still must pump the destructive proppant sand due to their inability to support high proppant-loading in the range of 25 PPA to 35 PPA in the dirty stream. By being able to support higher proppant-loading, an improved split stream method could dramatically reduce the number of pumps required to pump the dirty stream.

Replacing the fluid-end on a high-pressure plunger pumps is extremely expensive, not only because the fluid end itself is expensive, but also due to the difficulty and timeliness required to perform the replacement and the lost revenues from equipment down-time. Valves, on the other hand are less expensive and relatively easy to replace, but require such frequent replacements that they comprise a large percentage of plunger pump maintenance expenses.

In addition, when a valve fails, the valve seat is often damaged as well, and seats are much more difficult to replace than valves due to the very large forces required to pull the seats out of the fluid-end. The tradeoff is that the higher the concentration of proppant; the fewer the number of pumps needed to pump the dirty stream with proppants and the greater the number of clean pumps that do not have to pump proppant. The damage to the dirty pumps is far outweighed by the increased useful life of the clean pumps.

In slickwater fracing operations that currently take place, approximately one-half of the pumps must pump the dirty stream because the proppants will not remain in suspension within the carrier fluid, and will settle out and will sink to the bottom of the fluid. The dirty stream cannot be pumped at concentrations greater than 10 PPA and is not often used above 6 PPA, which prevents the use of fewer than one half of the pumps by this split stream prior art method. A means to support higher concentration levels of solids is needed. Prior art U.S. Pat. No. 9,016,383 B2 fails to cite a carrier fluid for the dirty stream that is capable of supporting proppants-loading greater than 12 PPA.

It is an object of the Present Patent to provide a method that requires the absolute minimum number of pumps by use of a Proppant Suspending Agent carrier fluid capable of supporting much higher proppant loading in the range of 12 PPA to 35 PPA, which is near to the maximum proppant concentration that can be pumped.

Prior art PCT Patent Number WO 2013/033391 A1 by Mahoney, et al. titled, “SELF-SUSPENDING PROPPANTS FOR HYDRAULIC FRACTURING” having an International filing date of Aug. 30, 2012 claims that the invention provides modified proppants, and methods for their manufacture. In embodiments, the modified proppant comprises a proppant particle and a hydrogel coating, wherein the hydrogel coating is applied to a surface of the proppant particle and localizes on the surface to produce the modified proppant. In embodiments, formulations are disclosed comprising the modified particles, and methods are disclosed for using the formulations.

A polyacrylamide hydrogel is applied to the surface of proppants normally used in hydraulic fracturing as a liquid spray that is subsequently dried to create the modified self-suspending proppant in some of the embodiments of their patent. The hydrogel increases in size up to 100 times as it hydrates, lowering its density and increasing its size and effectively increasing the size and lowering the density of the modified proppant to better harness the movement of the frac fluid being pumped into a wellbore under high pressure.

The following paragraphs are quotes from the Patent's Background, “¶[0004] . . . There are three common types of polymer-enhanced fluid systems in general use for suspending and transporting proppants during hydraulic fracturing operations: slickwater, linear gel, and crosslinked gel. ¶[0005] In slickwater systems, an anionic or cationic polyacrylamide is typically added as a friction reducer additive, allowing maximum fluid flow with a minimum of pumping energy. Since the pumping energy requirements of hydraulic fracturing are high, on the order of 10,000-100,000 horsepower, a friction reducer is added to slickwater fluids to enable high pumping rates while avoiding the need for even higher pumping energy. While these polymers are effective as friction reducers, they are not highly effective as viscosifiers and suspending agents. Slickwater polymer solutions typically contain 0.5-2.0 gallons of friction reducer polymer per 1000 gallons of slickwater fluid, and the solutions have low viscosity, typically on the order of 3-15 cps. At this low viscosity, suspended proppant particles can readily settle out of suspension as soon as turbulent flow is stopped. For this reason, slickwater fluids are used in the fracturing stages that have either no proppant, proppant with small particle size, or low proppant-loadings. ¶[0006] The second type of polymer enhanced fluid system is known as a linear gel system. Linear gel systems typically contain carbohydrate polymers such as guar, hydroxyethylcellulose, hydroxyethyl guar, hydroxypropyl guar, and hydroxypropylcellulose. These linear gel polymers are commonly added at a use rate of 10-50 pounds of polymer per 1000 gallons of linear gel fluid. These concentrations of linear gel polymer result in a fluid with improved proppant suspending characteristics vs. the slickwater fluid. The linear gel fluids are used to transport proppants, at loading levels of about 0.1 to 1 pound of proppant per gallon of fluid. Above this level, a more viscous solution is typically required to make a stable suspension. ¶[0007] Crosslinked gel is the most viscous type of polymer-enhanced fluid used for transporting of proppant. In crosslinked gel systems, the linear gel fluid as described above is crosslinked with added reagents such as borate, zirconate, and titanate in the presence of alkali. Upon crosslinking of the linear gel fluid into a crosslinked gel fluid, the viscosity is much higher, and the proppants can be effectively suspended. The linear gel and crosslinked gel fluids have certain advantages, but they require a high dose rate of expensive polymer”.

The false belief that polyacrylamide can serve only as a polymer friction reducer that is highly ineffective as viscosifiers or as proppant suspending agents is widely held in the industry. Previous oilfield experience with the material as a slickwater polymer friction reducer used at the low concentrations, typically around 0.5-2.0 gallons of friction reducer polymer per 1000 gallons of slickwater fluid, and the solutions have low viscosity, typically on the order of 3-15 cps. At this low viscosity, suspended proppant particles can readily settle out of suspension as soon as turbulent flow is stopped. The test results shown herein prove that polyacrylamide can serve as an effective proppant suspension agent, contrary to prior art claims.

The primary chemical used in the current shale fracturing process is a polyacrylamide friction reducer (FR) which is used to reduce the surface treating pressure by lowering the friction of the fluid flowing through the piping in the wellbore. These friction reducers can lower the pressure due to friction by 60% -90%, which can result in over a 1,000 psi reduction in pumping pressure. The lower treating pressure reduces the horsepower and fuel required to do a treatment, which reduces metal fatigue on the fracturing equipment.

Polyacrylarnide friction reducers also increase the fluid viscosity slightly in the range of 3-15 centipoise, which seems small, but greatly reduces the settling velocity of the proppant in the fluid, as per Stokes Law. Changing the viscosity (with all other parameters the same) directly changes the terminal settling velocity of the proppant which is directly proportional to the viscosity increase, whereby this process creates a new hydraulic fracturing process that eliminates the costlier fluid chemicals used in the past that were primarily guar bean gum and its derivatives, (G, HPG, CMG, CMHPG, etc.).

The new hydraulic fracturing process without the conventional fracturing chemicals is now referred to as “waterfrac” or “slickwater frac”. This process is the predominant process used today in horizontal shale plays in the United States. The current friction reducers used by this method are made from polyacrylamide and can be tailored to address fluid issues caused by salt and dissolved solids.

For relatively fresh water with a low number of dissolved solids, the primary friction reducer is an anionic polyacrylamide. For medium salinity with a medium number of dissolved solids in the water, an anionic polyacrylamide with AMPS is used; and, for high salinity with a high level of dissolved solids in the water, a cationic polyacrylamide is normally used. Adjusting the polyacrylamide formations to address the water salinity and the level of dissolved solids in the water adds to the costs of the friction reducers.

Another type of fracturing known as “foam fracturing” was prevalent in the past; where either Nitrogen (N₂) or Carbon Dioxide (CO₂) was used to reduce the quantity of water required. The compressibility of the N₂ and the CO₂ also energized the fluid to improve fluid recovery after the fracturing treatment, which was common for low pressure wells or water sensitive formations. In these treatments the proppant was mixed at very high concentrations, sometimes as high as 25 PPA.

The concentrated slurry was then diluted with either N₂ gas or liquid CO₂ to produce a much lower concentration in the range of 1 PPA to 10 PPA at the surface before entering the wellbore. As a rough example, a foam frac treatment with 80% N₂ or CO₂ would reduce the heavily laden 25 PPA slurry down to a proppant concentration of about 5 PPA for the final fracturing operation (the actual final proppant concentration varies due to the compressibility of these gaseous fluids, but it is not relevant for this simple explanation example).

The foam fracturing process required very few fracturing pumps for the proppant laden slurry due to the very high proppant concentration, near the maximum PPA attainable. The primary fluid used to suspend the proppant was high loading of guar gum or one of its derivatives and in many cases a crosslinker and surfactant as a foaming agent. The high loading of gelling agents was also reduced down in the same ratio as the proppant when the N2 or CO2 was mixed with the high concentrated gel and high sand concentration.

The same foam frac concepts using highly concentrated proppant slurry was considered for the relatively new waterfrac application. However, the chemistry needed to be compatible with the new waterfrac treatments and be able to suspend the high concentration of proppant of 25 PPA. The suspending agent, when mixed with the larger volume of clean proppant free fluid, needs to reduce the proppant suspending agent back to a reasonable level so that the new chemistry would not change the general practices used in the waterfrac process.

### SUMMARY OF INVENTION

The present invention overcomes the above problem by providing a method for preparation of a polyacrylamide fluid forming a proppant suspending agent comprising a polyacrylamide in a concentration of 0.10% to 0.90% active polyacrylamide in an aqueous solution by weight of the mix fluid to form a proppant suspending agent.

In view of the foregoing, an embodiment herein provides improved method for preparation of a polyacrylamide fluid whereby polyacrylamide (poly(2-propenamide) or poly(1-carbamoylethylene), abbreviated as PAM) is a polymer (—CH2CHCONH2-) formed from acrylamide subunits, whereby the polyacrylamide proppant suspending agent fluid can suspend the normal ranges of granular materials used as fracturing proppants having mesh sizes in the range from 400 mesh to 20/40 mesh, whereby the granular proppant materials used as fracturing proppants have a specific gravity ranging from 1.25 to 3.30, whereby the concentration of polyacrylamide in the proppant suspending agent is adjusted to match the proppant mesh size and specific gravity to suspend proppant concentrations in the range of 10 PPA to 35 PPA to form a proppant laden slurry, whereby for pressure pumping, the maximum concentration of proppant in the liquid mix is when the fluid volume is within the range of 10% to 30% more than the pore volume of the proppant material used in the mix.

In one of the embodiment, the method uses polyacrylamide which is an anionic polymer modified with AMPS (2-Acrylamido-2-methylpropane sulfonic acid), a cationic polymer and a non-ionic polymer. The polyacrylamide includes any co-polymers and a crosslinking chemical added to crosslink the polyacrylamide using one of the trivalent metals commonly used in fracturing fluids wherein the crosslinker is a trivalent form of Boron, Zirconium, Aluminum, Titanium, Chrome and Iron. A buffering chemical is used to adjust the pH of the fluid in the proper range for crosslinking with a trivalent metal ion. The aqueous mix fluid is potable water, fresh water, saline water, produced water, flowback water or any mixture thereof. The method further comprises other additives selected from the group comprising of surfactants, scale inhibitors, microbiocides, clay control and mixtures thereof.

In another embodiment, the proppant laden slurry is pumped into a wellbore or is pumped into a pipeline for transport to a nearby oilfield or is pumped to a more distant location as liquid proppant laden slurry. The proppant laden liquid slurry product with high concentrations of proppant is prepared onsite or alternatively is prepared at an off-site location, such as a proppant sand mine, and is transported by rail car, tank truck or other suitable means to a distant location where used, eliminating the need for onsite production and thereby reducing onsite time and labor, traffic congestion, dust and particulate formation, along with other benefits of off-site production of the proppant suspending agent to produce a pre-prepared proppant laden liquid slurry as a marketable product. The polyacrylamide proppant laden fluid is used in the prior art split stream hydraulic fracturing method to reduce the number of trucks required to pump the dirty stream due to the increased concentration of proppant suspended therein, thereby improving upon the split stream hydraulic fracturing method.

In yet another embodiment, the polyacrylamide proppant laden fluid used in the split stream hydraulic fracturing method comprises an aqueous frac fluid solution having polyacrylamide dissolved therein at a concentration in the range of 0.10% to 0.90% by weight of the mix fluid provides a dual-use, dual-function fluid that improves upon the prior art split stream hydraulic fracturing method, the fluid is used as a proppant suspending agent at the full concentration level cited above to suspend granular proppant particles at concentrations in the range of 10 PPA to 35 PPA, which is a higher proppant concentration range than the concentration range of 0.25PPA to 6 PPA normally used in the prior art split stream method, the active polyacrylamide fluid after first being used as a proppant suspending agent having polyacrylamide dissolved therein at a concentration of 0.10% to 0.90% by weight of the mix fluid to suspend the proppant laden slurry to pump the dirty stream with its high concentration of proppants to a wellbore at the wellsite as the dirty stream, the concentration of polyacrylamicle is diluted on the surface at the wellsite with additional proppant free clean fluid to normal friction reduction concentration levels in the range of 0.008% to 0.064% and is used again as a polyacrylamide friction reducer (FR) fluid commonly used in “water fracturing” or “slickwater fracturing” as a second use, the proppant concentration is likewise diluted on the surface by the additional proppant free clean fluid to the concentration of 0.25PPA to 6 PPA normally used in “water fracturing” or “slickwater fracturing” operation. The polyacrylamide frac fluid diluted to the level commonly used as a friction reducer (FR) and with the proppant concentration reduced to that normally used in slickwater fracturing operations, they are mixed together then injected into the wellbore to perform an improved modified split stream method of hydraulic fracturing. The same active polyacrylamide material is beneficially used at two entirely different fluid concentration levels for two entirely different functions performed at two different times in the split stream hydraulic fracturing method. The first use is on the surface for the purpose of acting as a proppant suspending agent and the second use is within the wellbore for the purpose of acting as a friction reducer, providing substantial cost savings by substantially reducing the number of pumps needed to pump the dirty stream for split stream hydraulic operations due to the high concentrations of proppant provided by the proppant suspending agent.

In one another embodiment, the polyacrylamide proppant laden fluid used in the split stream hydraulic fracturing method is an aqueous frac fluid solution having polyacrylamide dissolved therein at a concentration in the range of 0.10% to 0.90% by weight of the mix fluid provides a dual-function fluid that improves upon the prior art split stream hydraulic fracturing method, the fluid is used as a proppant suspending agent at the full concentration level cited above to suspend granular proppant particles at concentrations of range of 10 PPA to 35 PPA, which is a higher proppant concentration range than the concentration range of 0.25 to 10 PPA normally used in the prior art split stream method, the polyacrylamide active fluid after being used as a proppant suspending agent having polyacrylamide dissolved therein at a concentration of 0.10% to 0.90% by weight of the mix fluid to suspend the proppant laden slurry so that it can be pumped to the site of a wellbore as the dirty stream, the concentration of polyacrylamide is diluted on the surface with additional clean fluid to normal friction reduction concentrations in the range of 0.008% to 0.064% and is used again as a polyacrylamide friction reducer (FR) fluid commonly used in “water fracturing” or “slickwater fracturing” as a second use, the proppant concentration is likewise diluted on the surface by the additional clean fluid to the concentration of 0.25 PPA to 6 PPA normally used in “water fracturing” or “slickwater fracturing” operations, the frac fluid with the polyacrylamide diluted to the level commonly used as a friction reducer (FR) and with the proppant concentration reduced to 0.25 PPA to 6 PPA normally used in “water fracturing” or “slickwater fracturing” operations, the frac fluid containing the lower concentration of proppant and lower concentration of polyacrylamide is injected into the wellbore to perform hydraulic fracturing operations and the same polyacrylamide active material is beneficially used at two entirely different fluid concentration levels for two entirely different functions performed at two different times in the split stream hydraulic fracturing method providing substantial cost savings and substantially reducing the number of pumps needed to pump the dirty stream for split stream hydraulic operations due to the high concentrations of proppant provided by the proppant suspending agent.

In yet another embodiment, a dual-use, dual-function polyacrylamide fluid comprises an aqueous frac fluid solution having polyacrylamide dissolved therein at a concentration in the range of 0.10% to 0.90% by weight of the mix fluid to form a proppant suspending agent that is capable of improving upon the prior art split stream hydraulic fracturing method wherein the split stream method splits the process into two streams; the dirty stream having granular proppant materials known as solids along with chemicals and other additives commonly used in hydraulic fracturing operations that are pumped by a first group of fracturing pumps to the wellbore and the proppant free clean stream that comprises clean mix fluid, typically fresh water, that is pumped to the wellbore by a second set of fracturing pumps, the normal ranges of granular materials used as fracturing proppants having mesh sizes in the range from 400 mesh to 20/40 mesh and having a specific gravity ranging from 1.25 to 3.30 are mixed into the polyacrylamide proppant suspending agent at concentrations in the range of 10 PPA to 35 PPA to form a proppant laden liquid slurry, the polyacrylamide proppant laden slurry due to the increased concentration of proppant suspended therein substantially reduces the number of fracturing pumps required to pump the dirty stream; thereby improving upon the split stream hydraulic fracturing method, the fluid is used as a proppant suspending agent at the concentration levels cited herein to suspend granular proppant particles at concentrations range of 10 PPA to 35 PPA, which is a higher proppant concentration range than the concentration range of 0.25 PPA to 6 PPA normally used in the prior art split stream surface pumping hydraulic fracturing operation method, the polyacrylamide fluid after being used as a proppant suspending agent to pump the proppant laden slurry to a wellbore is diluted on the surface with additional proppant free clean fluid to the normal friction reduction concentrations levels in the range of 0.008% to 0.064% commonly used in “water fracturing” or “slickwater fracturing” to serve as a polyacrylamide friction reducer (FR) as a second use, the proppant concentration is likewise diluted by the additional proppant free clean fluid to the concentration of 0.25 PPA to 6 PPA that is normally used in “water fracturing” or “slickwater fracturing”, and the same polyacrylamide active material is beneficially used at two entirely different fluid concentration levels for two entirely different purposes or functions performed at two different times in the split stream hydraulic fracturing method providing substantial cost savings and substantially reducing the number of pumps needed to pump the dirty stream for split stream hydraulic operations.

In another embodiment, the fluid comprises a polyacrylamide in a concentration of 0.05% to 2.5% active polyacrylamide in an aqueous solution by weight of the mix fluid to form a suspending agent fluid that can suspend a wide range of small granular solid materials having mesh sizes ranging from 50 mesh to 10/20 mesh and specific gravity ranging from 1.05 to 5 wherein small granular solid materials are selected from such species as a wide variety of woods, coal, copper concentrate, gilsonite, asphalt, bitumen, mineral ores, sands, limestone, magnetite, a wide variety of sands, cement, charcoal, glass particles, to name just a few of the many small granular solids that can be transported as a liquid slurry laden with small granular solid materials, the concentration of polyacrylamide in the solids suspending agent is adjusted to match the mesh size and specific gravity of the solid materials to suspend solids in concentration levels in the range of 2 PPA to 35 PPA to form a solids laden slurry, the solids can remain in suspension within the solids suspending agent for at least one hour, which is deemed enough time to pump the solids laden liquid slurry into a pipeline for transport to a nearby location for use, and the solids laden liquid slurry is transported by rail tanker car, tanker truck or other suitable means to a more distant location for use.

These and other aspects of the embodiments herein will be better appreciated and understood when considered in conjunction with the following description. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### DETAILED DESCRIPTION OF THE INVENTION

The novel idea was to start with 25 PPA proppant slurry and determine the dilution ration needed to get back to 0.25 PPA to 8 PPA proppant. Then determine the concentration range of polyacrylamide that, when diluted at the same ratio as that of the proppant, would yield a polyacrylamide concentration in the friction reducer range of 0.008% to 0.064% by weight of the mix fluid commonly used in waterfrac operations to provide a dual-use, dual-function Proppant Suspending Agent frac fluid. The calculations led to a Proppant Suspending Agent mix range of 0.10% to 0.90% by weight of mix fluid.

Table 1 illustrates the common oilfield polyacrylamide usage ranges and introduces the new Proppant Suspending Agent mix ranges for this patent. Table 1 show how the Proppant Suspending Agent is in a new medium range which fits between the two commonly used mixture ranges in the conventional waterfrac treatments.

The group labeled “Low” is the normal concentration used as a Friction Reducer (FR) in conventional waterfrac treatments.

The group labeled “High” is the dry powder Normal Powder Premix polyacrylamide range before dilution into the waterfrac treatment stream with additional fresh water.

The group labeled “Medium” is the new mixture range established for this patent as the Proppant Suspending Agent providing a dual-fluid application that serves as a Proppant Suspending Agent (Medium) that is then diluted back to the Friction Reducer range (Low), allowing the proppant suspending agent to perform a dual-use and a dual-function in the hydraulic fracturing surface pumping operations during two different stages of the process.

TABLE 1

| | | | | Gal./MGal. |
|---|---|---|---|---|
| Nomen- | | % #Poly./ | # Poly./ | Liquid |
| clature | Application | #Water | 1000 | Emulsion FR |
| Low | Friction Reducer | 0.008% | 0.67 | 0.25 |
| Low | Friction Reducer | 0.032% | 2.67 | 1.00 |
| Low | Friction Reducer | 0.048% | 4.01 | 1.50 |
| Low | Friction Reducer | 0.064% | 5.34 | 2.00 |
| Medium | Proppant Suspending Agent | 0.10% | 8.33 | 3.12 |
| Medium | Proppant Suspending Agent | 0.50% | 41.65 | 15.60 |
| Medium | Proppant Suspending Agent | 0.90% | 74.97 | 28.08 |
| High | Normal Powder Premix | 1.00% | 83.30 | 31.20 |
| High | Normal Powder Premix | 2.00% | 166.60 | 62.40 |
| High | Normal Powder Premix | 2.25% | 187.43 | 70.20 |
| High | Normal Powder Premix | 2.50% | 208.25 | 78.00 |

Nomenclature:
(% #P/# Water) Percentage of the Polyacrylamide Active Material in Pounds in Ratio to the Weight of Water in pounds (Dry Material)
(# Poly./1000) The Number of Pounds of Polyacrylamide Active Material Per One Thouand Gallons of Frac Fluid

Testing of the idea was performed with the two most prevalent proppants used in the waterfrac hydraulic fracturing process, 100 mesh sand and 40/70 mesh sand. The proppants were mixed into the two predetermined polymer mix concentrations of 0.25% and 0.50%. The 0.25% mixture completely suspended the 100 mesh sand for over one hour which was deemed plenty sufficient to pump the heavily laden proppant slurry. The 0.25% mixture completely suspended the 40/70 mesh sand for 10 minutes, which might be sufficient for normal pumping operations, provided there were no lengthy unplanned shutdowns. The 0.50% mixture completely suspended the 40/70 mesh sand for over 1 hour (as well as the 100 mesh sand) which was deemed adequate to pump the heavily laden proppant slurry with 40/70 mesh sand.

A Static Proppant Setting Test was performed as shown in Table 2. For testing, two concentration mixtures were selected in the range (0.25% and 0.50% ) for the proppant suspension testing to determine the ability of a polyacrylarnide solution to suspend proppant.

TABLE 2

| | % of Fluid | | | |
|---|---|---|---|---|
| | 0.25% PSA-w/ | 0.25% PSA-w/ | 0.50% PSA-w/ | 0.50% PSA- |
| | 25 lb/gal | 25 lb/gal | 25 lb/gal | w/25 lb/gal |
| Time | (100 Mesh | (40/70 Mesh | (100 Mesh | (40/70 Mesh |
| (min.) | loading) | loading) | loading) | loading) |
| 0 | 100 | 100 | 100 | 100 |
| 10 | 100 | 100 | 100 | 100 |
| 20 | 100 | 96 | 100 | 100 |
| 30 | 100 | 95 | 100 | 100 |
| 40 | 100 | 95 | 100 | 100 |
| 50 | 100 | 95 | 100 | 100 |
| 60 | 100 | 95 | 100 | 100 |

The Static Proppant Settling Test confirms that, as the particle size increases, so does the need for more viscous fluid, as predicted by Stokes Law. However, the long molecular-chain in the polyacrylamide polymers helps to support sand above and beyond the simple viscosity effects predicted by Stokes Law. The mixture will need to be tailored to the size and specific gravity of the proppant being used.

Proppant mesh sizes in waterfrac treatments range from 400 mesh to 20/40 mesh and specific gravity of the proppants can range from 1.25 to 3.30. Therefore, variations in the proppant suspending agent mix concentrations are required to match the Proppant Suspending Agent fluid to the proppant mesh size and specific gravity planned for each treatment. The variation should fall within the bounds of the mix percentages originally calculated in the range of 0.10% to 0.90%.

Table 3 is a graph of the Proppant Suspension Test Results.

The proppant suspending agent allows the near maximum concentration of proppant to be mixed and transported at 25 PPA and, depending on the specific gravity and porosity of the proppant, could be higher, near 35 PPA.

Once the appropriate proppant suspending agent mix percentage is determined for the specific gravity and mesh sizes of proppant for a given fracturing treatment, one can set the max mix concentration of proppant in the proppant suspending agent and calculate the proppant concentration needed to provide both the desired dilute proppant concentration and desired polyacrylamide concentration for each proppant stage to match the treatments design concentrations for the normal conventional waterfrac operation.

This calculation results in a new treatment plan that includes the proppant PPA concentration needed in the proppant suspending agent to obtain the desired friction reducer concentration. Then, the proppant slurry rate is adjusted to obtain the desired final proppant concentration and the proppant free clean fluid rate to achieve the desired treating rate for the treatment design. The proppant suspending agent is diluted to the proper concentration to meet the friction reduction design while also matching the designed proppant concentration for the fracturing treatment.

Using the polyacrylamide as the proppant suspending agent provides a dual-use and a dual-function fluid to transport high concentrations of proppant and to act as a friction reducer when diluted, which also lowers the pumping pressure required to pump the proppants and reduces the pump damage from proppants to a minimum, while performing the fracturing treatment with the same chemicals and proppant concentrations normally used in the industry.

Lowering or raising the proppant slurry concentration allows the polyacrylamide to be diluted to the 0.008% to 0.064% range that is normally used for friction reduction additive, such that changing the ratio of the dirty slurry rate to the clean fluid rate at a given concentration will vary the diluted final proppant concentration. This new process allows waterfrac pumping operations to be performed similar to foam fracturing pumping operations, using a proppant suspending agent of polyacrylamide to reduce the number of dirty fluid pumps to a minimum.

Reducing the number of pumps handling the proppant slurry to a minimum, reduces the damage, downtime and maintenance costs to a majority of the fracturing pumps required to perform a waterfrac treatment and will increase the mean time to failure for the majority of fracturing pumps, since they only pump a clean proppant-free fluid. This will reduce pump maintenance time, saving service companies maintenance cost, increase equipment utilization, and increase their monthly revenues per fracturing spread.

Below are two examples to show the dual functionality of the Polyacrylamide to suspend proppant and then subsequently be diluted to the normal Friction Reducer range, by changing the Blender Proppant Concentration and Dirty Rate to match the Waterfrac Treatment design objectives while pumping 82-95% proppant-free clean fluid through the majority of the fracturing pumps.

### EXAMPLE 1

Example 1 demonstrates the dual-function of the Polyacrylamide Proppant Suspending Agent (mixed at 0.25% by weight of mix fluid) simultaneously diluting the polyacrylamide back to the designed Friction Reducer concentration and proppant concentration for a waterfrac treatment.

The spreadsheet algorithms calculate the new proppant-free Blender Clean Fluid Rate to match the Designed Friction Reducer Equivalent, determines the New Blender Proppant Concentration, Blender Dirty Fluid Rate and the Proppant Free Clean Fluid rate to match the conventional waterfrac treatment pumping method. In this example the new proppant concentration is ˜10.4 times more than the conventional treatment, which is a significant improvement.

In a conventional waterfrac treatment, the blender Dirty Rate is the same as the Treatment Designed Dirty Rate, in this case :100 BPM. Using the Proppant Suspending Agent, the Blender Dirty Fluid Rate is reduced by 80-90%, saving wear and tear on the blender due to lower fluid velocities.

To further illustrate the compositions and methods of the present invention, Example 1 is given in Table 4.

TABLE 4
Example 1
Initial Condition of PSA mix Concentration and Max Proppant Concentration

| | |
|---|---|
| PSA Mix Conc. | 0.25% |
| Proppant Max PPA Conc. | 25 |

Treatment Designed Liquid Emulsion Polyacrylamide Concentration (Gal./MGal.)
Dilution Calculations

| | Proppant | | | | |
|---|---|---|---|---|---|
| | Suspending | | | | |
| Treatment | Agent | | | | |
| Designed Liquid | Equivalent | | Proppant | | |
| Emulsion | Liquid Emulsion | Proppant | Stage | Treatment | Treatment |
| Polyacrylamide | Polyacrylamide | Stage Clean | Clean | Designed | Designed |
| Concentration | After Dilution | Volume | Volume | Injection | Proppant |
| (Gal./Mgal.) | (Gal./MGal.) | (BBLs) | (Gallons) | Rate (BPM) | Conc. (PPA) |
| 0.750 | 0.75 | 500 | 21,000 | 100 | 0 |
| 0.750 | 0.75 | 400 | 18,800 | 100 | 0.25 |
| 0.750 | 0.75 | 400 | 18,800 | 100 | 0.50 |
| 0.750 | 0.75 | 400 | 18,800 | 100 | 0.75 |
| 0.750 | 0.75 | 602 | 25,360 | 100 | 1.00 |
| 0.750 | 0.75 | 1000 | 42,000 | 100 | 1.25 |
| 0.750 | 0.75 | 1200 | 50,400 | 100 | 1.50 |
| 0.750 | 0.75 | 1600 | 87,200 | 100 | 1.75 |
| 0.750 | 0.75 | 2000 | 84,000 | 100 | 2.00 |
| 0.750 | 0.75 | 476 | 20,000 | 100 | 2.25 |
| 0.750 | 0.75 | 300 | 12,800 | 100 | 0.00 |

| | | Conventional | | | |
|---|---|---|---|---|---|
| New Blender | | Blender Clean | | New Treatment | |
| Proppant | New Blender | Rate for | Proppant | Wellbore | |
| Conc. With | Discharge | Mixing | Free Fluid | Injection | |
| Limit @ 25 | Rate with PSA | Proppant | Make-Up | Rate | Stage Time |
| PPA | Fluid (BPM) | (BPM) | Rate (BPM) | (BPM) | (Minutes) |
| 0.00 | 9.82 | 100.00 | 90.38 | 100 | 5.00 |
| 2.60 | 10.84 | 98.87 | 89.36 | 100 | 4.08 |
| 5.20 | 11.83 | 97.77 | 88.37 | 100 | 4.09 |
| 7.80 | 12.81 | 96.69 | 87.39 | 100 | 4.14 |
| 10.40 | 13.58 | 96.63 | 86.44 | 100 | 6.30 |
| 13.00 | 14.49 | 94.80 | 85.51 | 100 | 10.57 |
| 15.80 | 15.41 | 93.59 | 84.59 | 100 | 12.82 |
| 18.20 | 18.38 | 92.60 | 83.78 | 100 | 17.28 |
| 20.80 | 17.18 | 91.83 | 82.82 | 100 | 21.83 |
| 23.40 | 18.03 | 96.88 | 81.97 | 100 | 5.25 |
| 0.00 | 9.62 | 100.00 | 80.38 | 100 | 3.00 |

Since the proppant suspending agent mix concentration is determined by the proppant size and specific gravity, once the predetermined max proppant concentration is reached, for example 25 PPA, increasing the proppant concentration in the final mix will also increase the polyacrylamide concentration slightly. In most cases it is within the normal polyacrylamide ranges for the normal friction reducer concentrations used in waterfrac treatments. However, this feature is an advantage, in that it is common practice to increase the friction reducer concentration as the proppant concentrations increase, or as the proppant mesh size increases.

### EXAMPLE 2

Example 2 demonstrates the dual-function of the Polyacrylamide Proppant Suspending Agent (mixed at 0.50% by weight of mix fluid for example) simultaneously diluting the polyacrylamide back to the Friction Reducer concentration range and designed proppant concentration for a waterfrac treatment.

The spreadsheet algorithm calculates the new Blender Clean Rate to match the designed Friction Reducer equivalent until the preset Blender Proppant Concentration Limit of 25 PPA is reached. When the Blender Proppant Concentration reaches the 25 PPA limit, the Friction Reducer concentration increases as the treatment proppant concentration is increased. The Blender Dirty Fluid Rate and Proppant Free Clean Fluid rate are calculated for performing the waterfrac treatment as designed. In this example, the new Proppant Concentration is 11 to 20 times more than the conventional treatment, which is a significant improvement.

In this example the higher the Mix Concentration (0.50% by weight of mix fluid) makes the Blender Proppant Concentration hit the 25 PPA limit and then the polyacrylamide concentration increases in the final dilution as the Proppant Concentration increases, but it is still within the normal “Low” range for Friction Reducer.

In a conventional treatment, the Blender Dirty Rate is the same as the Treatment Designed Dirty Rate, which in this case 100 BPM. Using the Proppant Suspending Agent, the Blender Dirty Fluid Rate is reduced by 82-95%, saving wear and tear on the blender due to lower fluid velocities.

This higher Polyacrylamide Mixture may be needed for larger proppant mesh sizes or higher specific gravity proppants, which normally use higher Polyacrylamide Friction Reducer Concentrations for these treatments.

To further illustrate the compositions and methods of the present invention, Example 2 is given as Table 5.

TABLE 5
Example 2
Initial Condition of PSA mix Concentration and Max Proppant Concentration

| | |
|---|---|
| PSA Mix Conc. | 0.50% |
| Proppant Max PPA Conc. | 25 |

Treatment Designed Liquid Emulsion Polyacrylamide Concentration
(Gal./MGal.) Dilution Calculations

| | Proppant | | | | |
|---|---|---|---|---|---|
| | Suspending | | | | |
| Treatment | Agent | | | | |
| Designed Liquid | Equivalent | | Proppant | | |
| Emulsion | Liquid Emulsion | Proppant | Stage | Treatment | Treatment |
| Polyacrylamide | Polyacrylamide | Stage Clean | Clean | Designed | Designed |
| Concentration | After Dilution | Volume | Volume | Injection | Proppant |
| (Gal./Mgal.) | (Gal./MGal.) | (BBLs) | (Gallons) | Rate (BPM) | Conc. (PPA) |
| 0.750 | 0.75 | 500 | 21,000 | 100 | 0 |
| 0.750 | 0.75 | 400 | 18,800 | 100 | 0.25 |
| 0.750 | 0.75 | 400 | 18,800 | 100 | 0.50 |
| 0.750 | 0.75 | 400 | 18,800 | 100 | 0.75 |
| 0.750 | 0.75 | 602 | 25,360 | 100 | 1.00 |
| 0.750 | 0.78 | 1000 | 42,000 | 100 | 1.25 |
| 0.750 | 0.94 | 1200 | 80,400 | 100 | 1.50 |
| 0.750 | 1.09 | 1600 | 87,200 | 100 | 1.75 |
| 0.750 | 1.25 | 2000 | 84,000 | 100 | 2.00 |
| 0.750 | 1.40 | 476 | 20,000 | 100 | 2.25 |
| 0.750 | 0.75 | 300 | 12,800 | 100 | 0.00 |

| | | Conventional | | | |
|---|---|---|---|---|---|
| New Blender | | Blender Clean | | New Treatment | |
| Proppant | New Blender | Rate for | Proppant | Wellbore | |
| Conc. With | Discharge | Mixing | Free Fluid | Injection | |
| Limit @ 25 | Rate with PSA | Proppant | Make-Up | Rate | Stage Time |
| PPA | Fluid (BPM) | (BPM) | Rate (BPM) | (BPM) | (Minutes) |
| 0.00 | 4.81 | 100.00 | 95.19 | 100 | 5.00 |
| 5.20 | 5.88 | 98.87 | 94.12 | 100 | 4.05 |
| 10.40 | 0.93 | 97.77 | 93.07 | 100 | 4.09 |
| 15.80 | 7.98 | 86.69 | 92.04 | 100 | 4.14 |
| 20.80 | 8.96 | 96.63 | 81.04 | 100 | 6.30 |
| 25.00 | 10.13 | 94.80 | 89.87 | 100 | 10.57 |
| 25.00 | 12.02 | 93.59 | 87.88 | 100 | 12.82 |
| 25.00 | 13.88 | 92.60 | 88.12 | 100 | 17.28 |
| 25.00 | 15.70 | 91.83 | 84.30 | 100 | 21.83 |
| 25.00 | 17.48 | 96.88 | 82.52 | 100 | 5.25 |
| 0.00 | 4.81 | 100.00 | 95.19 | 100 | 3.00 |

These two examples clearly show the dual functionality of the Polyacrylamide to suspend proppant being diluted back to the normal Friction Reducer range to perform a conventional Waterfrac Treatment, allowing 82-95% of the Treating Rate to be Proppant-Free Clean Fluid, reducing the damage to the majority of fracturing pumps.

Using larger proppant sizes or higher specific gravity proppants involves higher mix percentage in the proppant suspending agent and the aforementioned issue may cause the polyacrylamide concentration in the diluted mixture to fall outside the normal friction reducer range. To address this issue, a lower concentration of polyacrylamide in the proppant suspending agent along with a crosslinker (trivalent metal of Boron, Zirconium, Aluminum, Titanium, etc., or any other trivalent metal ions or combination thereof) can be added to enhance the proppant suspending properties of the polyacrylamide at a lower mix percentage to reach the diluted range for normal friction reduction for waterfrac treatments, while keeping the dirty fluid pumps to a minimum.

The proppant suspending agent process has a self-healing feature, in the event of a sudden unplanned drop in the proppant free clean rate (for example: a clean side fracturing pump stops pumping) the polyacrylamide concentration increases by the nature of this process helping to transport a sudden increase in the diluted proppant concentration. Taking this to the extreme, if the entire clean fluid rate stops, the fluid in the piping manifold reverts to the proppant suspending agent concentration. This slurry may not be suitable to pump down the wellbore but can be flushed out of the lines to a tank, so the equipment issues can be corrected and surface operations restarted. The self-healing feature is seen to be very advantageous to the surface pumping operations of a waterfrac treatment to increase safety while reducing downtime.

Another test, with the proppant suspending agent mixed at 0.50% active polyacrylamide material by weight with 25 PPA using 100 mesh proppants, kept the proppant suspended for over twenty-four (24) hours. With gentle agitation, the proppant can be suspended for several clays. This feature allows proppant to be mixed into a slurry and transported to a distant location in a liquid slurry form. Making the proppant laden slurry at the proppant source and delivering concentrated proppant slurry directly to the fracturing location, eliminates OSHA-regulated dusting issues from handling dry particulate material on the wellsite.

Preparation of the proppant laden slurry off-site also eliminates the need for the conventional fracturing blender on location to blend the proppant into the frac fluid, thereby reducing equipment cost, fuel and manpower for the fracturing operation. Making a sand slurry at the mine could be done without fully drying the sand by adjusting the polyacrylamide concentration for the proppant suspending agent to account for the moisture content in the proppant. The polyacrylamide concentration is adjusted so that the resulting mixture is at the appropriate proppant suspending agent concentration for suspending and transporting a proppant having a specific proppant mesh size and a specific gravity. Not having to fully dry the sand will beneficially reduce energy cost and increase the mine throughput capacity.

Using premixed proppant slurry at a constant proppant PPA reduces the operational flexibility. With a constant PPA in the proppant suspending agent, only the final proppant dilution can be matched and the polyacrylamide available for friction reduction may be below the friction reducer range desired for the diluted proppant concentration in the early sand stages of low-diluted proppant concentrations, but will increase linearly with the diluted proppant concentration.

At the low diluted proppant concentrations, an additional source of polyacrylamide will be needed to get the polyacrylamide up to the normal levels for friction reduction concentrations of 0.008% to 0.064%. Using a concentrated proppant suspending agent slurry at a constant concentration has a slightly different operating procedure requiring an additional source of polyacrylamide to meet the normal treatment design specifications, but still uses the reduced number of dirty pumps and has the self-healing feature.

In Summary, tests result conclusively prove that polyacrylamide in the proper range (specifically being Medium) can be used as a proppant suspending agent and disproves the prior false belief that polyacrylamide can serve only as a polymer friction reducer and that it is highly ineffective as a Viscosifier or as a proppant suspending agent, as is widely believed in the industry due to previous oilfield experience using the material as a slickwater polymer friction reducer at low concentrations.

The test results have shown that polyacrylamide can absolutely serve as an effective proppant suspending agent when used in the medium range of 0.10% to 0.90% by weight of the mix fluid to suspend proppant solid materials concentrations of 10 PPA up to 35 PPA to form a proppant laden slurry, which is near to the maximum proppant concentrations possible to pump. Whereby the slurry can be pumped into a wellbore or into a pipeline or otherwise transported by rail tanker car or tanker truck in the liquid slurry form to provide a marketable pre-prepared proppant-laden slurry product.

### DESCRIPTIONS OF THE FIGURES WHICH COMPRISING CHARTS, TABLES AND EXAMPLES

FIG. 1 presents Table 1 that compares the two commonly used oilfield polyacrylamide mix ranges labeled “Low” and “High” to the use of the proposed new Proppant Suspending Agent mix range of 0.10% to 0.90% by weight of the mix fluid labeled as “Medium”, which fits between the two ranges most often used in conventional waterfrac treatments that is disclosed herein as a dual-use, dual-purpose or function “Medium” range that can serve as a Proppant Suspending Agent to support high levels of proppant loading; and, after dilution by mixing with proppant-free, fresh clean mix fluid to the “Low” range of 0.008% to 0.064% by weight of the mix fluid, serves as a Friction Reducer (FR) to lower friction and thereby reduce the required pumping pressure as is further described and disclosed herein.

The group labeled “Low” is the normal concentration that is used as a Friction Reducer (FR) in conventional waterfrac treatments.

The group labeled “High” is the dry powder Normal Powder Premix polyacrylamide range before dilution into the waterfrac treatment stream with additional fresh water.

FIG. 2 presents Table 2 which is a photographic image depicting the Proppant Suspending Agent Settling Duration Test performed at the direction of the Present Inventor to validate the effectiveness of the dual-use, dual-purpose, dual-function polyacrylamide prepared within the Medium concentration range of 0.008% to 0.064% that is the Method of the Present Invention as is further disclosed herein. The cylinders shown are filled with a carrier fluid comprising varying concentrations of the polyacrylamide Proppant Suspending Agent and with proppant of varying mesh sizes.

The Settling Duration Test shown in Table 2 was performed as proof-of-concept to evaluate if the polyacrylamide chemical is effective as a Proppant Suspending Agent to keep proppant solid particles in sizes commonly used in the industry in suspension for sufficient durations as to be pumped into a wellbore in liquid slurry form.

FIG. 3 presents Table 3 which shows that after more than sixty minutes of settling time all the graduated cylinders having frac fluids with concentrations of polyacrylamide of 0.50% remained in suspension supporting both the 100 mesh and the 40/70 mesh proppant at the high proppant suspension concentration of 25 PPA (pounds of proppant added) per gallon of frac fluid as is indicated by the lines at the 100% level on the chart.

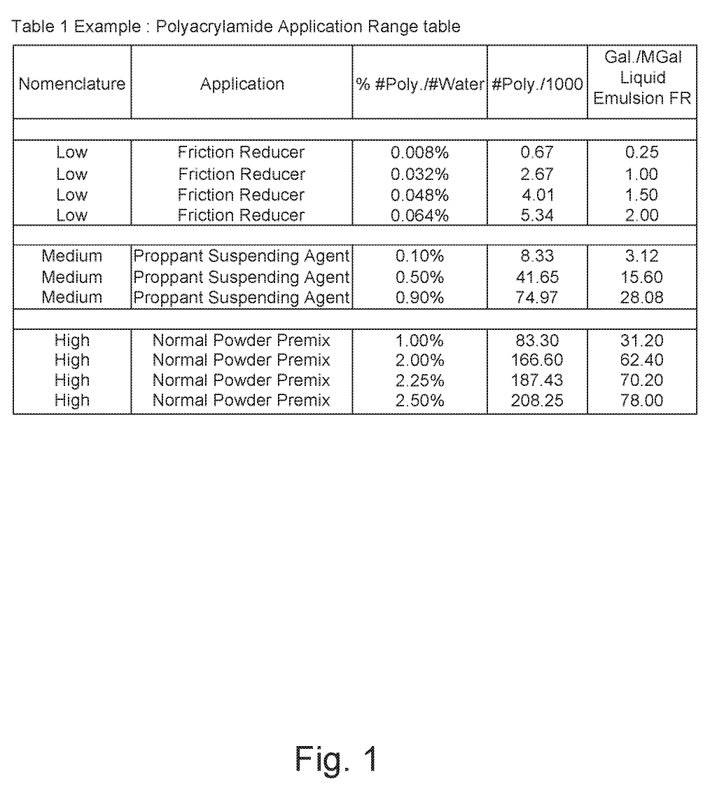

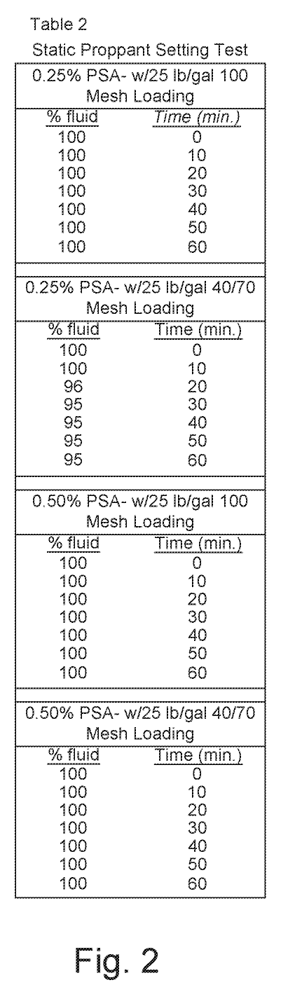

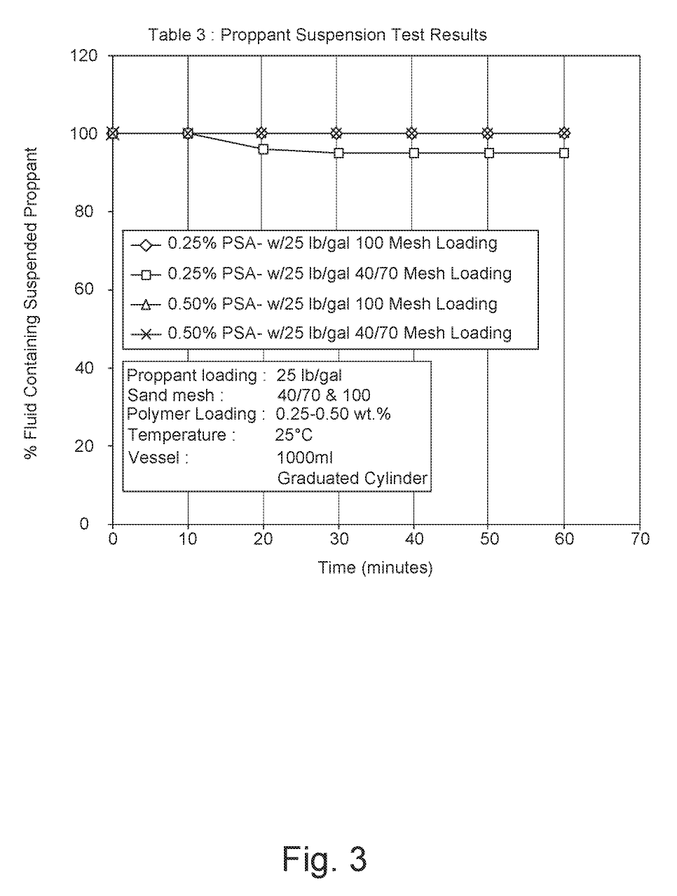

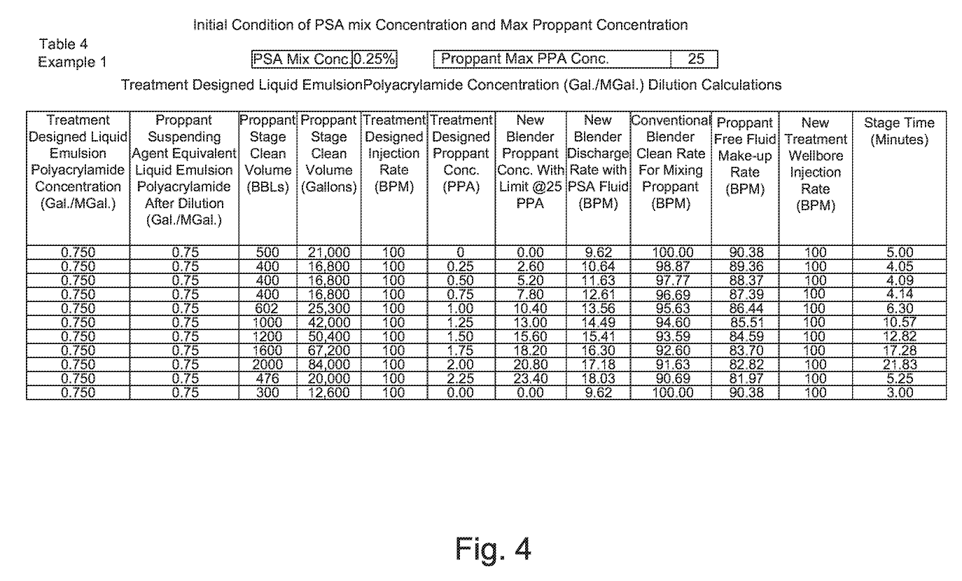

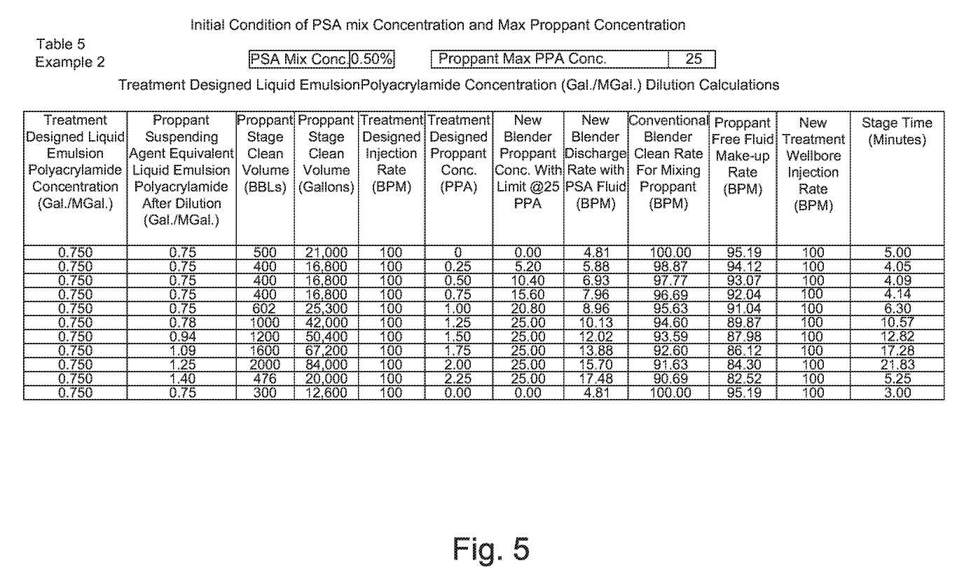

Table 3 graphically presents the results of the successful Settling Duration Test shown in the black and white photograph displayed in Table 2. Table 3 presents a chart that demonstrates the percentage of the concentration of polyacrylamide active material within the frac fluid versus the duration of time various meshes of concentrated proppant loading at 25 pounds per gallon remain in suspension within the frac fluid.

The tests were performed using an amount of polyacrylamide active material in the dry powder form, which was dissolved into a mix fluid and fully hydrated. Two polyacrylamide concentrations were used. The first concentration of polyacrylamide was at 0.25% by weight of mix fluid and the second concentration of polyacrylamide was at 0.50% by weight of the mix fluid.

The results were that the 0.50% polyacrylamide active material concentration level met the criteria for suspending the 100 mesh and the 40/70 mesh proppant at the high proppant suspension concentration of 25 PPA (pounds of proppant added per gallon of frac fluid) for a period of at least one hour, which is sufficiently long enough duration to successfully pump the dirty stream into the clean stream on the surface before injection into the wellbore.

However, the lower 0.25% polyacrylamide active material concentration level met the criteria for the 100 mesh proppant but only kept the 40/70 mesh proppant in suspension for ten minutes which indicates that a small additional amount of polyacrylamide active material needs to be added as the mesh size increases.

The results of the study indicate that the concept of producing a Proppant Suspending Agent works in the Medium range, which can successfully perform the method of the Invention as disclosed herein. The test results also show that there is room to optimize the mixtures with different concentrations and different molecular weights of polyacrylamide powders. It is reasonable that a concentration of polyacrylamide in the mid-range between those used of 0.35% -0.45% by weight may be more preferred to produce suspension of both the 100 mesh and the 40/70 mesh proppant at a lower concentration than the larger 0.50% by weight concentration used in the tests, so that costs are reduced using less polyacrylamide active material.

The Proppant Suspending Agent Mix Concentration is determined by the proppant size and specific gravity once the predetermined max proppant concentration is reached, for example 25 PPA, increasing the proppant concentration in the final mix will also increase the polyacrylarnide concentration slightly. In most cases it is within the normal polyacrylamide ranges for the normal friction reducer concentrations used in waterfrac treatments. However, this feature is an advantage in that it is common practice to increase the friction reducer concentration as the proppant concentrations increase, or proppant mesh size increases.

FIG. 4 presents Example 1 that provides a comparison of the prior art conventional method of performing hydraulic fracturing to the proposed new method that uses a Proppant Suspending Agent to suspend proppants at very high concentrations in the range of 10 to 35 PPA. The Chart indicates that the Polyacrylamide Concentrations and the Proppant Concentration after dilution are in the proper ranges for all of the lines in the chart regarding Example 1.

FIG. 5 presents Example 2 which demonstrates the dual-function of the Polyacrylamide Proppant Suspending Agent (mixed at 0.50% by weight of mix fluid for example) simultaneously diluting the polyacrylamide back to the Friction Reducer concentration range and designed proppant concentration for a waterfrac treatment.

The spreadsheet algorithm calculates the new Blender Clean Rate to match the designed Friction Reducer equivalent until the preset Blender Proppant Concentration Limit of 25 PPA is reached. When the Blender Proppant Concentration reaches the 25 PPA limit, the Friction Reducer concentration increases as the treatment proppant concentration is increased. The Blender Dirty Fluid Rate and Proppant Free Clean Fluid rate are calculated for performing the waterfrac treatment as designed. In this example the new Proppant Concentration is 11 to 20 times more than the conventional treatment.

In this example the higher the Mix Concentration (0.50% by weight of mix fluid) makes the Blender Proppant Concentration hit the 25 PPA limit and then the polyacrylamide concentration increases in the final dilution as the Proppant Concentration increases but is still within the normal “Low” range for Friction Reducer.

In a conventional treatment the Blender Dirty Rate is the same as the Treatment Designed Dirty Rate in this case 100 BPM. Using the Proppant Suspending Agent the Blender Dirty Fluid Rate is reduced by 82-95% saving wear and tear on the blender due to lower fluid velocities.

This higher Polyacrylamide Mixture may be needed for larger proppant mesh sizes or higher specific gravity proppants which normally use higher Polyacrylamide Friction Reducer Concentrations for these treatments.

As mentioned, there remains the foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood, however, that even though numerous characteristics and advantages of the present invention have been set forth in the foregoing description, together with details of the structure and function of the invention, the disclosure is illustrative only. Changes may be made in the details, especially in matters of compositions of the fluid and its components within the principles of the invention to the full extent indicated by the broad general meaning of the terms in which the appended claims are expressed.

What is claimed is:

1. A method for preparation of a polyacrylamide fluid forming a proppant suspending agent comprising a polyacrylamide in a concentration of 0.10% to 0.90% active polyacrylamide in an aqueous solution by weight of the mix fluid to form a proppant suspending agent,
whereby polyacrylamide (poly(2-propenamide) or poly(1-carbarnoylethylene), abbreviated as PAM) is a polymer (—CH2CHCONH2-) formed from acrylamide subunits;
whereby the polyacrylamide proppant suspending agent fluid can suspend the normal ranges of granular materials used as fracturing proppants having mesh sizes in the range from 400 mesh to 20/40 mesh;
whereby the granular proppant materials used as fracturing proppants have a specific gravity ranging from 1.25 to 3.30;
whereby the concentration of polyacryiamide in the proppant suspending agent is adjusted to match the proppant mesh size and specific gravity to suspend proppant concentrations in the range of 10 PPA to 35 PPA to form a proppant laden slurry;
whereby for pressure pumping, the maximum concentration of proppant in the liquid mix is when the fluid volume is within the range of 10% to 30% more than the pore volume of the proppant material used in the mix.

2. The method for preparation of a polyacrylamide fluid forming a proppant suspending agent according to claim 1, whereby the polyacrylamide is an anionic polymer.

3. The method for preparation of a polyacrylamide fluid forming a proppant suspending agent according to claim 1, whereby the polyacrylamide is anionic polymer modified with AMPS (2-Acrylamido-2-methylpropane sulfonic acid),

4. The method for preparation of a polyacrylamide fluid forming a proppant suspending agent according to claim 1, whereby the polyacrylamide is a cationic polymer.

5. The method for preparation of polyacrylamide fluid forming a proppant suspending agent according to claim 1, whereby the polyacrylamide is a non-ionic polymer.

6. The method for preparation of polyacrylamide fluid forming a proppant suspending agent according to claims 1, whereby the polyacrylamide includes any co-polymers.

7. The method for preparation of polyacrylamide fluid forming a proppant suspending agent according to claims 1, whereby a crosslinking chemical is added to crosslink the polyacrylamide using one of the trivalent metals commonly used in fracturing fluids.

8. The method for preparation of polyacrylamide fluid forming a proppant suspending agent according to claims 7, whereby the crosslinker is a trivalent form of Boron, Zirconium, Aluminum, Titanium, Chrome, Iron.

9. The method for preparation of polyacrylamide fluid forming a proppant suspending agent according to claims 1, whereby a buffering chemical is used to adjust the pH of the fluid in the proper range for crosslinking with a trivalent metal ion.

10. The method for preparation of polyacrylamide fluid forming a proppant suspending agent according to claims 1, whereby the aqueous mix fluid is potable water, fresh water, saline water, produced water, flowback water or any mixture thereof.

11. The method for preparation of polyacrylarnide fluid forming a proppant suspending agent according to claim 1, whereby the method further comprising other additives selected from the group comprising of surfactants, scale inhibitors, microbiocides, clay control and mixtures thereof.

12. The method for preparation of polyacrylamide fluid forming a proppant suspending agent according to claim 1, whereby the proppant laden slurry is pumped into a wellbore or is pumped into a pipeline for transport to a nearby oilfield or is pumped to a more distant location as a liquid proppant laden slurry.

13. The method for preparation of a polyacrylamide fluid forming a proppant suspending agent according to claim 1, whereby the proppant laden liquid slurry product with high concentrations of proppant is prepared onsite or alternatively is prepared at an off-site location, such as a proppant sand mine, and is transported by rail car, tank truck or other suitable means to a distant location where used, eliminating the need for onsite production and thereby reducing onsite time and labor, traffic congestion, dust and particulate formation, along with other benefits of off-site production of the proppant suspending agent to produce a pre-prepared proppant laden liquid slurry as a marketable product.

14. The method for preparation of a polyacrylamide fluid forming a proppant suspending agent according to claim 1, whereby the polyacrylamide proppant laden fluid is used in the prior art split stream hydraulic fracturing method to reduce the number of trucks required to pump the dirty stream due to the increased concentration of proppant suspended therein, thereby improving upon the split stream hydraulic fracturing method.

15. The method for preparation of a polyacrylamide fluid forming a proppant suspending agent according to claim 1, whereby an aqueous frac fluid solution having polyacrylamide dissolved therein at a concentration in the range of 0.10% to 0.90% by weight of the mix fluid provides a dual-use, dual-function fluid that improves upon the prior art split stream hydraulic fracturing method;
whereby the fluid is used as a proppant suspending agent at the full concentration level cited above to suspend granular proppant particles at concentrations in the range of 10 PPA to 35 PPA, which is a higher proppant concentration range than the concentration range of 0.25 PPA to 6 PPA normally used in the prior art split stream method;
whereby the active polyacrylamide fluid after first being used as a proppant suspending agent having polyacryl larnide dissolved therein at a concentration of 0.10% to 0.90% by weight of the mix fluid to suspend the proppant laden slurry to pump the dirty stream with its high concentration of proppants toa wellbore at the wellsite as the dirty stream;
whereby the concentration of polyacrylamide is diluted on the surface at the wellsite with additional proppant free clean fluid to normal friction reduction concentration levels in the range of 0.008% to 0.064% and is used again as a polyacrylamide friction reducer (FR) fluid commonly used in “water fracturing” or “slickwater fracturing” as a second use;
whereby the proppant concentration is likewise diluted on the surface by the additional proppant free clean fluid to the concentration of 0.25 PPA to 6 PPA normally used in “water fracturing” or “slickwater fracturing” operations;
whereby with the polyacrylamide frac fluid diluted to the level commonly used as a friction reducer (FR) and with the proppant concentration reduced to that normally used in slickwater fracturing operations, they are mixed together then injected into the wellbore to perform an improved modified split stream method of hydraulic fracturing;
whereby the same active polyacrylamide material is beneficially used at two entirely different fluid concentration levels for two entirely different functions performed at two different times in the split stream hydraulic fracturing method the first use is on the surface for the purpose of acting as a proppant suspending agent and the second use is within the wellbore for the purpose of acting as a friction reducer, providing substantial cost savings by substantially reducing the number of pumps needed to pump the dirty stream for split stream hydraulic operations due to the high concentrations of proppant provided by the proppant suspending agent.

16. The method for preparation of polyacrylamide fluid forming a proppant suspending agent according to claim 1, whereby the polyacrylamide proppant laden fluid used in the prior art split stream hydraulic fracturing method to reduce the number of trucks required to pump the dirty stream due to the increased concentration of proppant suspended therein, thereby improving upon the split stream hydraulic fracturing method,
whereby an aqueous frac fluid solution having polyacrylamide dissolved therein at a concentration in the range of 0.10% to 0.90% by weight of the mix fluid provides a dual-function fluid that improves upon the prior art split stream hydraulic fracturing method;
whereby the fluid is used as a proppant suspending agent at the full concentration level cited above to suspend granular proppant particles at concentrations of range of 10 PPA to 35 PPA, which is a higher proppant concentration range than the concentration range of 0.25 to 10 PPA normally used in the prior art split stream method;
whereby the polyacrylamide active fluid after being used as a proppant suspending agent having polyacrylamide dissolved therein at a concentration of 0.10% to 0.90% by weight of the mix fluid to suspend the proppant laden slurry so that it can be pumped to the site of a wellbore as the dirty stream;
whereby the concentration of polyacrylamide is diluted on the surface with additional clean fluid to normal friction reduction concentrations in the range of 0.008% to 0.064% and is used again as a polyacrylamide friction reducer (FR) fluid commonly used in “water fracturing” or “slickwater fracturing” as a second use;
whereby the proppant concentration is likewise diluted on the surface by the additional clean fluid to the concentration of 0.25 PPA to 6 PPA normally used in “water fracturing” or “slickwater fracturing” operations;
whereby the frac fluid with the polyacrylamide diluted to the level commonly used as a friction reducer (FR) and with the proppant concentration reduced to 0.25 PPA to 6 PPA normally used in “water fracturing” or “slickwater fracturing” operations, the frac fluid containing the lower concentration of proppant and lower concentration of polyacrylamide is injected into the wellbore to perform hydraulic fracturing operations;
whereby the same polyacrylamide active material is beneficially used at two entirely different fluid concentration levels for two entirely different functions performed at two different times in the split stream hydraulic fracturing method providing substantial cost savings and substantially reducing the number of pumps needed to pump the dirty stream for split stream hydraulic operations due to the high concentrations of proppant provided by the proppant suspending agent.

17. A dual-use, dual-function polyacrylamide fluid comprising an aqueous frac fluid solution having polyacrylamide dissolved therein at a concentration in the range of 0.10% to 0.90% by weight of the mix fluid to form a proppant suspending agent that is capable of improving upon the prior art split stream hydraulic fracturing method,
whereby the split stream method splits the process into two streams; the dirty stream having granular proppant materials known as solids along with chemicals and other additives commonly used in hydraulic fracturing operations that are pumped by a first group of fracturing pumps to the wellbore and the proppant free dean stream that comprises clean mix fluid, typically fresh water, that is pumped to the wellbore by a second set of fracturing pumps;
whereby the normal ranges of granular materials used as fracturing proppants having mesh sizes in the range from 400 mesh to 20/40 mesh and having a specific gravity ranging from 1.25 to 3.30 are mixed into the polyacryiamide proppant suspending agent at concentrations in the range of 10 PPA to 3.5 PPA to form a proppant laden liquid slurry;
whereby the polyacrylarnide proppant laden slurry due to the increased concentration of proppant suspended therein substantially reduces the number of fracturing pumps required to pump the dirty stream; thereby improving upon the split stream hydraulic fracturing method;
whereby the fluid is used as a proppant suspending agent at the concentration levels cited herein to suspend granular proppant particles at concentrations range of 10 PPA to 35 PPA, which is a higher proppant concentration range than the concentration range of 0.25 PPA to 6 PPA normally used in the prior art split stream surface pumping hydraulic fracturing operation method;
whereby the polyacrylarnide fluid after being used as a proppant suspending agent to pump the proppant laden slurry to a wellbore is diluted on the surface with additional proppant free dean fluid to the normal friction reduction concentrations levels in the range of 0.008% to 0.064% commonly used in “water fracturing” or “slickwater fracturing” to serve as a polyacrylamide friction reducer (FR) as a second use;
whereby the proppant concentration is likewise diluted by the additional proppant free dean fluid to the concentration of 0.25 PPA to 6 PPA that is normally used in “water fracturing” or “slickwater fracturing”;
whereby the same polyacrylamide active material is beneficially used at two entirely different fluid concentration levels for two entirely different purposes or functions performed at two different times in the split stream hydraulic fracturing method providing substantial cost savings and substantially reducing the number of pumps needed to pump the dirty stream for split stream hydraulic operations.

18. A fluid comprising a polyacrylamide in a concentration of 0.05% to 2.5% active polyacrylamide in an aqueous solution by weight of the mix fluid to form a suspending agent fluid that can suspend a wide range of small granular solid materials having mesh sizes ranging from 50 mesh to 10/20 mesh and specific gravity ranging from 1.05 to 5,
whereby small granular solid materials are selected from such species as a wide variety of woods, coal, copper concentrate, gilsonite, asphalt, bitumen, mineral ores, sands, limestone, magnetite, a wide variety of sands, cement, charcoal, glass particles, to name just a few of the many small granular solids that can be transported as a liquid slurry laden with small granular solid materials;
whereby the concentration of polyacrylamide in the solids suspending agent is adjusted to match the mesh size and specific gravity of the solid materials to suspend solids in concentration levels in the range of 2 PPA to 35 PPA to form a solids laden slurry;
whereby the solids can remain in suspension within the solids suspending agent for at least one hour, which is deemed enough time to pump the solids laden liquid slurry into a pipeline for transport to a nearby location for use;
whereby the solids laden liquid slurry is transported by rail tanker car, tanker truck or other suitable means to a more distant location for use.
